(19) United States
(12) Patent Application Publication
(10) Pub. No.: US 2022/0337492 A1
(43) Pub. Date: Oct. 20, 2022

(54) METHODS AND APPARATUS TO PROVIDE NETWORK PROVIDER RECOMMENDATIONS BASED ON DEMOGRAPHICS

(71) Applicant: The Nielsen Company (US), LLC, New York, NY (US)

(72) Inventor: Igor Sotosek, Portoroz (SI)

(21) Appl. No.: 17/721,168

(22) Filed: Apr. 14, 2022

Related U.S. Application Data
(60) Provisional application No. 63/175,407, filed on Apr. 15, 2021.

(51) Int. Cl. H04L 41/50; H04L 41/5061; H04L 41/5067

(52) U.S. Cl. CPC H04L 41/5032; H04L 41/5064; H04L 41/5067

(57) ABSTRACT

Methods, apparatus, systems, and articles of manufacture are disclosed to provide network provider recommendations based on demographics. An example apparatus includes a network performance analyzer to determine a service performance of a first network provider based demographic information and network measurement data, the demographic information corresponding to subscribers of the first network provider, the network measurement data corresponding to services of the first network provider, and a report generator to generate a report of the service performance of the first network provider, the report including a recommendation for a demographic group to use a second network provider based on the service performance not satisfying a threshold, the second network provider different from the first network provider.

### RELATED APPLICATION

This patent arises from a patent application that claims benefit of U.S. Provisional Patent Application No. 63/175,407, which was filed on Apr. 15, 2021. U.S. Provisional Patent Application No. 63/175,407 is hereby incorporated herein by reference in its entirety. Priority to U.S. Provisional Patent Application No. 63/175,407 is hereby claimed.

### FIELD OF THE DISCLOSURE

This disclosure relates generally to network communication systems and, more particularly, to methods and apparatus to provide network provider recommendations based on demographics.

### BACKGROUND

Internet usage has increased rapidly over the years. Internet is used for a multitude of different purposes, such as for work, for communication, to shop, to stay up-to-date on the news, and more. The demand for reliable (e.g., seamless connectivity at fast speeds) Internet is ever increasing. In some examples, network providers attempt to meet these demands by installing cellular towers at locations based on subscriber density, building fiber-optic networks, etc. However, network providers do not provide the same coverage with such towers and networks in every city, state, country, town, etc.

### BRIEF DESCRIPTION OF THE DRAWINGS

FIG. 1 is an example system to obtain and monitor network provider performance.

FIG. 2 is a block diagram of an example meter of FIG. 1 to obtain network measurement data and demographic information.

FIG. 3 is a block diagram of an example central facility of FIG. 1 to generate reports of network provider performance.

FIG. 4 is a flowchart representative of example machine readable instructions which may be executed to implement the meter of FIGS. 1 and 2 to collect network measurement data and demographic information.

FIG. 5 is a flowchart representative of example machine readable instructions which may be executed to implement the central facility server of FIGS. 1 and 3 to generate network measurement files for subsequent analysis.

FIG. 6 is a flowchart representative of example machine readable instructions which may be executed to implement the central facility server of FIGS. 1 and 3 to generate report(s) of network performance.

FIG. 7 is a block diagram of an example processing platform structured to execute the instructions of FIG. 4 to implement the meter of FIGS. 1 and 2.

FIG. 8 is a block diagram of an example processing platform structured to execute the instructions of FIGS. 5 and 6 to implement the central facility of FIGS. 1 and 3.

FIG. 9 is a block diagram of an example software distribution platform to distribute software (e.g., software corresponding to the example computer readable instructions of FIGS. 4-6) to client devices such as consumers (e.g., for license, sale and/or use), retailers (e.g., for sale, re-sale, license, and/or sub-license), and/or original equipment manufacturers (OEMs) (e.g., for inclusion in products to be distributed to, for example, retailers and/or to direct buy customers).

FIG. 10 is a block diagram of an example implementation of the processor circuitry of FIG. 7 and/or the processor circuitry of FIG. 8.

FIG. 11 is a block diagram of another example implementation of the processor circuitry of FIG. 7 and/or the processor circuitry of FIG. 8.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmed with instructions to perform specific operations and including one or more semiconductor-based logic devices (e.g., electrical hardware implemented by one or more transistors). Examples of processor circuitry include programmed microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of the processing circuitry is/are best suited to execute the computing task(s).

### DETAILED DESCRIPTION

The figures are not to scale. In general, the same reference numbers will be used throughout the drawing(s) and accompanying written description to refer to the same or like parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name. As used herein, “approximately” and “about” refer to dimensions that may not be exact due to manufacturing tolerances and/or other real world imperfections. As used herein, “substantially real time” refers to occurrence in a near instantaneous manner recognizing there may be real-world delays for computing time, transmission, etc. Thus, unless otherwise specified, “substantially real time” refers to real time+/−1 second.

Network service providers around the world advertise their services as the best (e.g., highest bandwidth, fastest download rates, etc.). However, such advertisements are likely not true or inaccurate for certain locations around the world. Network service providers (NSPs) build and maintain fiber optic cable and core routers (e.g., principle data routes) that make up the Internet. Their physical connections come together at Internet exchange points, which is where regional Internet Service Providers (ISPs) can connect to an NSP backbone. Therefore, a buyer having a subscription to an NSP in a location where fiber optic cable and core routers were not built may receive no services and/or poor services, such as slower download speeds, low connectivity, etc. For example, in locations where a particular NSP is not available to a buyer (e.g., locations where no fiber optic cables and/or core routers exist), some services are available to buyers that enable buyers to utilize satellite internet and/or a digital subscriber line (DSL). In some examples, there are locations where a particular NSP has not updated the cable network from copper to fiber-optic. In such examples, a buyer having a subscription to an NSP in a location where a copper cable network has not been upgraded to a fiber optic cable network may receive poor services. As used herein, “network provider,” “network service provider,” and “Internet provider,” are all terms used interchangeably to refer to a network service provider.

Examples disclosed herein collect network measurement data and user experience data to use for identifying network performance of network providers in different locations and for different demographics. Examples disclosed herein utilize meters to collect network measurement data and demographic information and report the data and information back to an audience measurement entity for determining network performance of network providers. In some examples, different meters collect network measurement data from different network providers, based on a panel member associated with a meter. For example, one panel member may have a subscription to a first network provider, a second panel member may have a subscription to a second network provider, and a third panel member may have a subscription with a third network provider.

Examples disclosed herein utilize cellular devices to collect network measurement data and demographic information and report the data and information back to an audience measurement entity for determining network performance of network providers. For example, meters are deployed to achieve a demographically equilibrated panel. To achieve a geographically equilibrated panel, examples disclosed herein utilize cellular devices (e.g., mobile phones such as smart phones or feature phones, tablet devices, smart watches, and/or other wearable smart devices, etc.) to collect and measure network data from different network providers across the globe. Some examples disclosed herein include a software meter installed in cellular devices to cause at least one processor to collect the network measurement data at different times of the day, at different locations, and for different demographic groups.

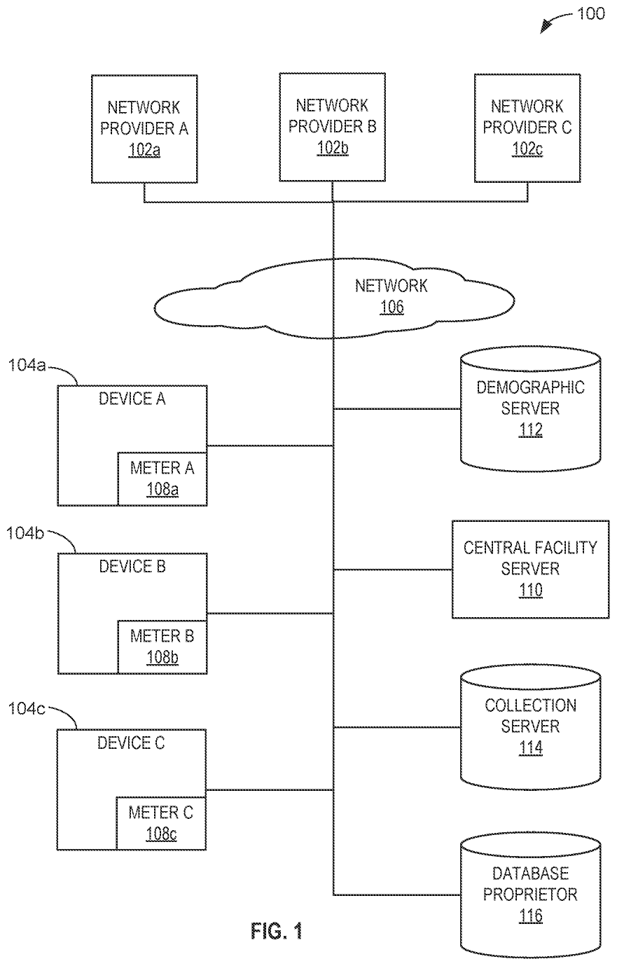

FIG. 1 is an example system 100 to obtain and monitor network provider performance. The example system 100 includes an example first network provider A 102a, an example second network provider B 102b, an example third network provider C 102c, an example first device A 104a, an example second device B 104b, an example third device C 104c, an example network 106, an example first meter A 108a, an example second meter B 108b, an example third meter C 108c, an example central facility server 110, an example demographic server 112, an example collection server 114, and an example database proprietor 116.

In the example of FIG. 1, the first network provider A 102a, the second network provider B 102b, and the third network provider C 102c may be referred to as the network providers 102. The example network providers 102 provide the first device A 104a, the second device B 104b, and the third device C 104c access to the network 106. In some examples, the network providers 102 advertise high-speed Internet, fast download rates, and more to panel members and/or any consumers to entice them to buy a network service subscription. In the example of FIG. 1, the first network provider A 102a, the second network provider B 102b, and the third network provider C 102c are different network providers. For example, network provider A 102a builds and maintains fiber optic cables and core routers separate from those of network providers B 102b and C 102c. In some examples, network provider A 102a may have better network performance in one location than network providers B 102b and C 102c. In some examples, network provider B 102b may have overall better network performance than network providers A 102a and C 102c.

In the example of FIG. 1, the first device A 104a, the second device B 104b, and the third device C 104c may be referred to as the example devices 104. The example devices 104 are user devices that retrieve and/or receive information from the network 106 for presentation. For example, the devices 104 may be media devices to receive and/or retrieve media, the devices 104 may be communication devices to exchange voice calls and communication messages, the devices 104 may be gaming devices to enable playing of video games, the devices 104 may be smart phones, etc., and/or any combination thereof. Additionally and/or alternatively, any other type(s) and/or number(s) of device(s) may additionally or alternatively be used. For example, video game consoles (e.g., Xbox® video game console, PlayStation® 3/4/5 video game console, etc.), tablet computers (e.g., an iPad® tablet, an Android® tablet, etc.), digital media players (e.g., an Apple TV® media player, a Roku® media player, a Slingbox® media player, a Tivo® media player, etc.), smart televisions, desktop computers, laptop computers, servers, Internet-of-Things (IoT) devices, watches (e.g., smartwatches), fitness trackers, headsets, vehicle control units (e.g., an engine control unit, an electronic control unit, etc.), edge devices, etc. may additionally or alternatively be used. The example devices 104 are provided with access to the network 106 via a subscription to one or more of the network providers 102a, 102b, and/or 102c. In some examples, the first device A 104a, the second device B 104b, and the third device C 104c have a subscription to the same network provider. In other examples, the first device A 104a, the second device B 104b, and the third device C 104c have different subscriptions to different ones of the network providers 102. For example, the first device A 104a accesses the network 106 using the first network provider A 102a, the second device B 104b accesses the network 106 using the second network provider B 102b, and the third device C 104c accesses the network 106 using the third network provider C 102c.

In FIG. 1, the example network 106 is a wide area network (WAN) such as the Internet. However, in some examples, local area networks may additionally or alternatively be used. Although the example network 106 is illustrated as a single network, multiple networks can be used by the devices 104. For example, multiple networks (e.g., a cellular network, an Ethernet network, etc.) may be utilized to implement the example network 106 of FIG. 1. In some examples, each of the network providers 102 may build and provide access to a separate network.

In FIG. 1, the example first device A 104a includes the example first meter A 108a, the example second device B 104b includes the example second meter B 108b, and the example third device C 104c includes the example third meter C 108c. The example first meter A 108a, the example second meter B 108b, and the example third meter C 108c may be referred to as the example meters 108. In the example of FIG. 1, the example meters 108 execute on the devices 104. In some examples, the meters 108 are applications created via a software development kit (SDK). In some examples, the meters 108 are standalone metering devices. In some examples, the meters 108 may be implemented via a webserver or web browser extensions.

In this example, the meters 108 collect and/or obtain network measurement data and demographic data associated with respective devices 104. In some examples, the meters 108 collect and/or obtain data or information associated with a quantity and/or type of service(s) (e.g., Internet service(s), software service(s), etc.) being used by the respective devices 104. In some such examples, the meters 108 collect and/or obtain data or information associated with a frequency and/or duration of use of the service(s), a measure of satisfaction with the service(s), etc. For example, the measure of satisfaction may be determined and/or otherwise based on feedback from a questionnaire or survey inquiring whether the panelist thought the Internet services were fast, satisfactory, slow, unsatisfactory, etc. In some such examples, the questionnaire or survey may be based on a ratings scale (e.g., a scale of 1-5 or 1-10, a scale of 1 to 5 stars, etc.), open-ended responses (e.g., a user may enter feedback into empty text boxes), etc., and/or a combination thereof.

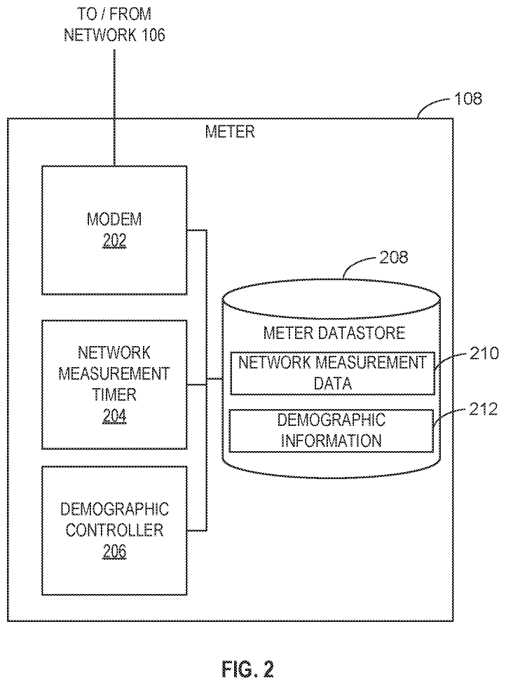

In some examples, the network measurement data includes different metrics, such as connectivity, latency, packet loss rate, bandwidth, data throughput, traffic, etc. Demographic information includes age, gender, race, ethnicity, income, marital status, job title, etc. In some examples, the meters 108 collect and/or obtain network measurement data on a periodic basis. For example, the meters 108 may send pings, traceroutes, and/or use any other technique periodically, such as every 30 minutes, every hour, once a day, etc., to capture network measurement data. In some examples, the meters 108 collect and/or obtain network measurement data on an aperiodic basis. For example, the meters 108 may send pings, traceroutes, and/or use any other technique at random times of the day, on randomly selected days, etc. In some examples, the meters 108 collect and/or obtain demographic information from the devices 104. For example, the meters 108 may query corresponding ones of the devices 104 for demographic information. In some examples, when a panelist registers a device and meter, the panelist provides basic demographic information during the registration, such as age and gender. In some examples, the meters 108 can request that the panelists provide more detailed information during registration. For example, additional demographic information may include race, ethnicity, income, marital status, job title, etc. In some examples, the meters 108 include modems, such as cellular modems, to communicate collected data (e.g., network measurement data and/or demographic data) to the central facility server 110, the demographic server 112, and/or the collection server 114. The example meters 108 are described in further detail below in connection with FIG. 2.

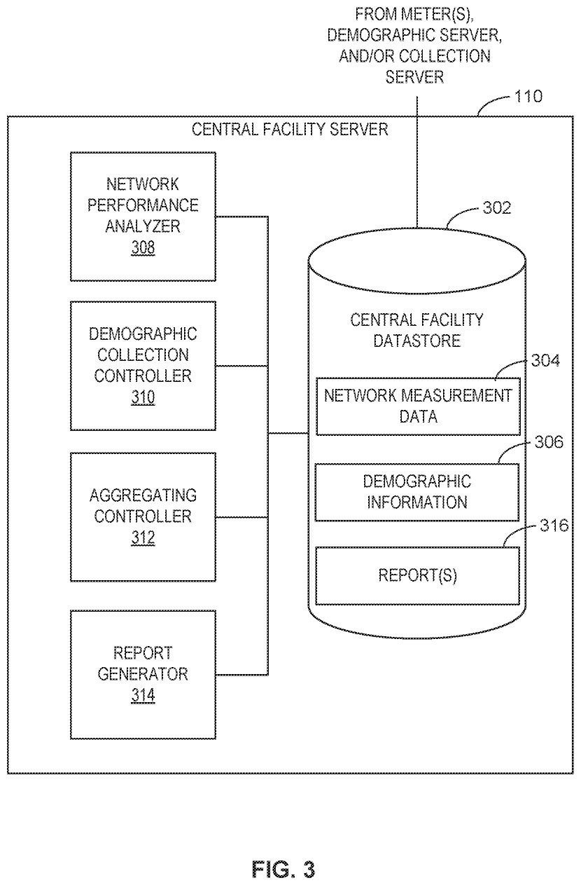

In the example of FIG. 1, the central facility server 110 generates reports indicative of the network performance for each of the network providers 102. In some examples, the central facility server 110 correlates network performance with different demographic groups to determine a network provider 102 that provides optimal services for the demographic group. For example, the central facility server 110 may analyze the type of Internet usage of each device 104, determine that a particular demographic group is associated with the type of Internet usage, and identify a network provider 102 that includes optimal network measurement data for that kind of Internet usage. In such examples, the central facility server 110 can recommend, to the people of the demographic group, that a particular network provider is most optimal or relatively better (e.g., provides the better services) for their Internet usage. The example central facility server 110 is described in further detail below in connection with FIG. 3.

In the example of FIG. 1, the demographic server 112 stores the demographic information obtained by the meters 108. In some examples, the demographic server 112 maintains demographic information collected by a database proprietor 116. In some examples, a panelist, or panel member, may have an identifier (e.g., a panelist identifier) that is mapped to demographic information of that panelist in the demographic server 112. For example, when a meter 108 collects demographic information corresponding to a panelist, the meter 108 maps the demographic information to the panelist identifier of that panelist. Similarly, when the database proprietor 116 collects demographic information, the database proprietor 116 maps the demographic information to user identifiers corresponding to the collected demographic information, where the user identifiers may or may not correspond to the panelist identifiers. For example, a database proprietor 116 may generate unique user identifiers different than panelist identifiers. In some examples, this is based on log in information or subscriber information that the database proprietor 116 requires, which can be different than the registration information required by the meter 108 (e.g., such as a different username, a different email, etc.). The example demographic server 112 is accessible and/or can be accessed by the central facility server 110.

In the example of FIG. 1, the collection server 114 stores network measurement data obtained by the meters 108. In some examples, the collection server 114 stores the network measurement data with a network provider identifier and a device identifier. In such examples, the network provider identifier identifies a corresponding one of the network providers 102, and the device identifier identifies a corresponding one of the devices 104. As such, the central facility server 110 can identify which metrics (e.g., network measurement data) correspond to which network provider based on the network provider identifier. In some examples, the collection server 114 stores location data corresponding to locations of the devices 104. In some examples, the location of a device 104 is logged generally or approximately as the fixed location of the cell tower through which the device 104 is communicating. To obtain the location information, the meters 108 may associate a cell tower identifier with the device identifier. A cell tower identifier is a unique number used to identify a cell tower within a location. In some examples, the meter 108 obtains the cell tower identifier from the device 104 and includes the cell tower identifier in the network measurement data. Therefore, in some examples, the collection server 114 stores the network measurement data, including the cell tower identifier, with a network provider identifier and a device identifier such that the central facility server 110 can identify which metrics correspond to which network provider 102 and at what location. In some examples, location information indicative of locations of the device 104 can be generated by the device 104 and provided to the collection server 114. For example, when location services are enabled on the device 104, the device 104 may use global positioning system (GPS) hardware and/or software to generate location coordinates as location information indicative of its location. In some examples, the collection server 114 is accessible and/or can be accessed by the central facility server 110.

In the example of FIG. 1, the database proprietor 116 provides demographic information to the central facility server 112. In general, the database proprietor 116 provides services to large numbers of subscribers (e.g., including panelists). The example database proprietor 116 may be a social network site (e.g., Facebook, Twitter, MySpace, etc.), a multi-service site (e.g., Yahoo!, Google, Axiom, Catalina, etc.), an online retailer site (e.g., Amazon.com, Buy.com, etc.), a credit reporting site (e.g., Experian), a streaming media site (e.g., YouTube, Hulu, etc.), etc. In exchange for the provision of services, the subscribers register with the database proprietor 116. As used herein, the term “registered user” refers to an individual who has established a user account with the database proprietor 116 (e.g., the individual who subscribes to the database proprietor 116). In some examples, the database proprietor 116 sets cookies and/or other device/user identifiers on the devices 104 of their registered users to enable the database proprietor 116 to recognize their registered users when their registered users visit website(s) on the Internet domains of the database proprietor 116.

The example database proprietor 116 includes demographic information corresponding to the registered user. For example, the database proprietor 116 includes demographic information for the particular registered user because the registered user would have provided such information when setting up an account to subscribe to the services of the database proprietor 116. Sharing of demographic information associated with registered users of the database proprietor 116 enables the central facility 110 to extend or supplement their panel data with substantially reliable demographics information from external sources (e.g., database proprietors), thus extending the coverage, accuracy, and/or completeness of their demographics-based network measurements. Any web service provider having a database identifying demographics of a set of individuals may cooperate with the central facility 110.

FIG. 2 is a block diagram of an example meter 108 of FIG. 1 to obtain network measurement data and demographic information. The example meter 108 may implement one or more of the example meters 108a-c of FIG. 1. The example meter 108 of FIG. 2 may be instantiated (e.g., creating an instance of, bring into being for any length of time, materialize, implement, etc.) by processor circuitry such as a central processing unit executing instructions. Additionally or alternatively, the example meter 108 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by one or more virtual machines and/or containers executing on the microprocessor.

The example meter 108 includes an example modem 202, an example network measurement timer 204, an example demographic controller 206, and an example meter datastore 208.

In FIG. 2, the example modem 202 enables the meter 108 and/or the device 104 of FIG. 1 to have wireless connectivity to the Internet and/or the network 106 of FIG. 1. In some examples, the modem 202 may be a cellular modem that adds 3G, 4G, 5G, and/or any other cellular connectivity to the meter 108 and/or device 104. In some examples, the modem 202 may be an external device that provides the meter 108 and/or the device 104 wireless connectivity to the network 106. In some examples, the modem 202 executes methods and techniques to obtain network measurement data. For example, the modem 202 may perform a ping to measure connectivity, round-trip time, and packet loss rate between two meters. In some examples, the modem 202 may perform a traceroute to measure round-trip time and a hop count between two meters. In some examples, the modem 202 performs Iperf and NetPerf to measure bulk transfer capacity between two meters. Additionally and/or alternatively, the modem 202 may utilize any network measurement technique to obtain network measurement data. In some examples, the values and times represented by these measurements are indicative of good network provider performance, mediocre network provider performance, and/or poor network provider performance.

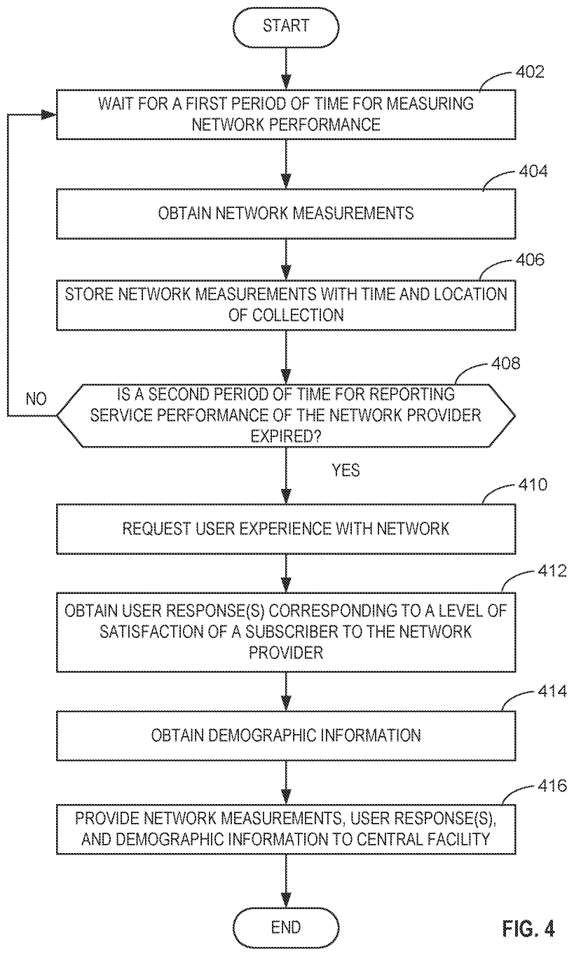

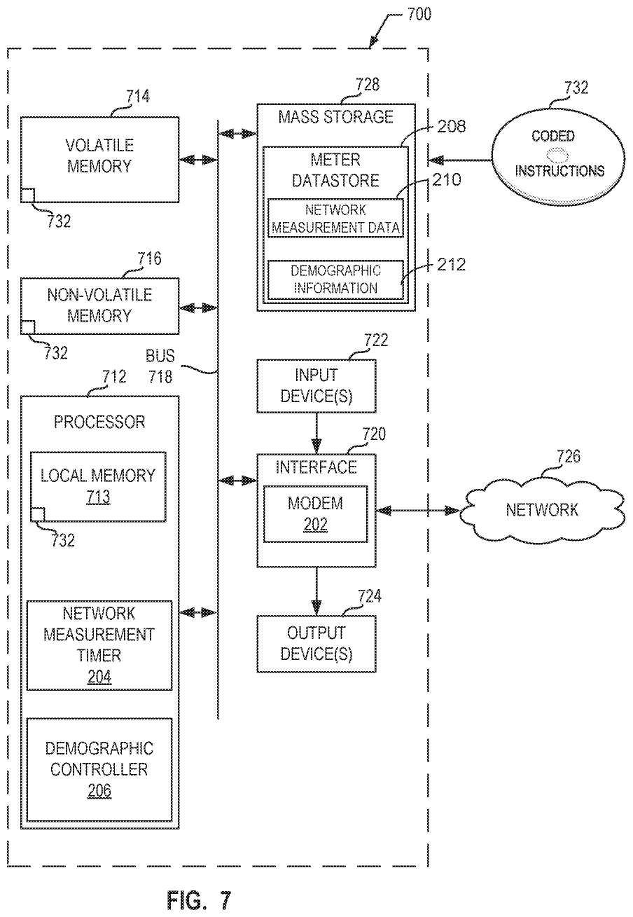

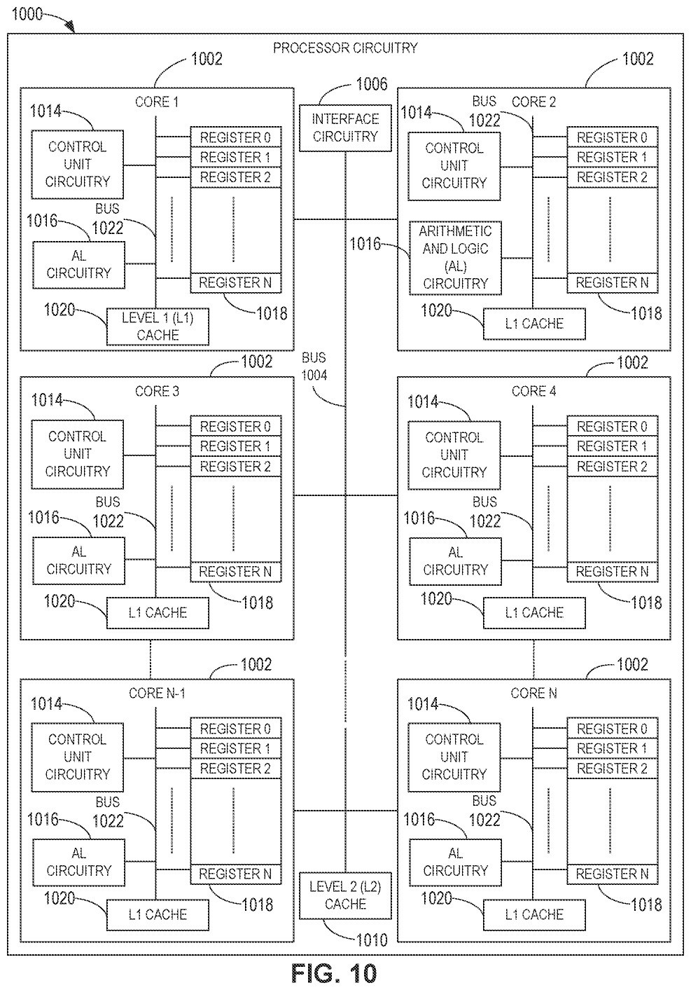

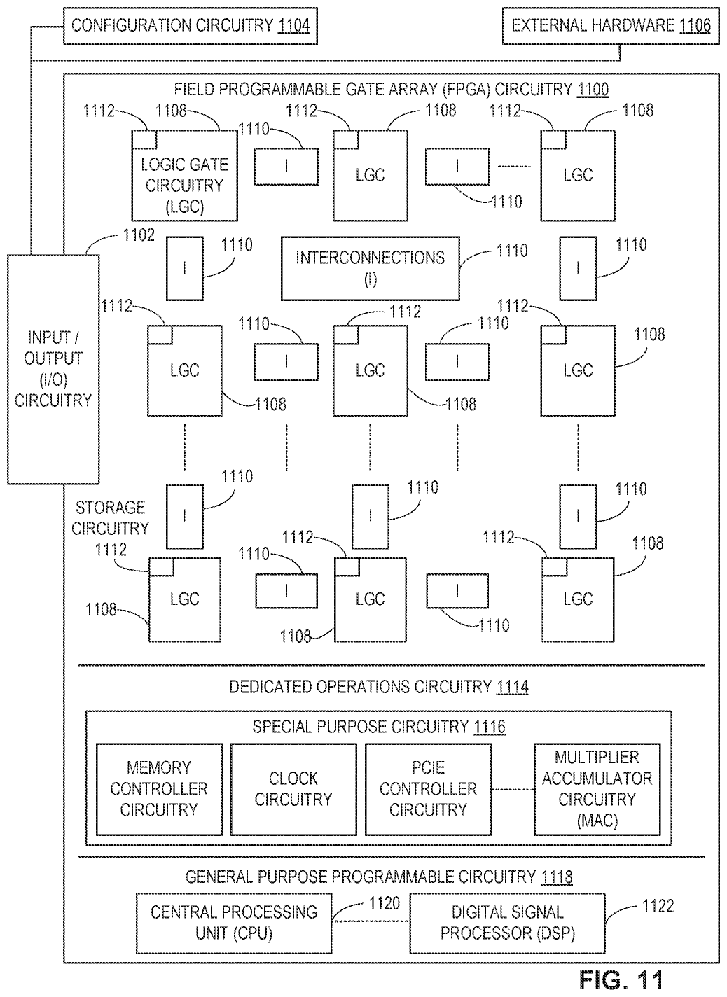

In some examples, the modem 202 includes means for obtaining network measurement data. For example, the means for obtaining network measurement data may be implemented by modem circuitry 202. In some examples, the modem circuitry 202 may be instantiated by processor circuitry such as the example processor circuitry 712 of FIG. 7. For instance, the modem circuitry 202 may be instantiated by the example general purpose processor circuitry 1000 of FIG. 10 executing machine executable instructions such as that implemented by at least blocks 404, 406, 408, and/or 416 of FIG. 4. In some examples, the modem circuitry 202 may be instantiated by hardware logic circuitry, which may be implemented by an ASIC or the FPGA circuitry 1100 of FIG. 11 structured to perform operations corresponding to the machine readable instructions. Additionally or alternatively, the modem circuitry 202 may be instantiated by any other combination of hardware, software, and/or firmware. For example, the modem circuitry 202 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the modem 202 includes means for storing network measurement data, means for determining whether a period of time for reporting network performance is expired, and/or means for sending and/or providing network measurement data to the central facility server 110.

In the example of FIG. 2, the network measurement timer 204 determines when the modem 202 is to collect network measurement data. For example, the network measurement timer 204 tracks a period of time, which may be predetermined by an audience measurement entity and/or an administrator at the central facility server 110, and then notifies the modem 202 to perform network measurements. In some examples, the timer 204 notifies the modem 202 to collect network measurement data during peak hours in a day (e.g., during higher volumes of network traffic such as after work, during busy days of special events, etc.). In some such examples, the central facility server 110 may generate a report indicative of how each network provider responds to a higher volume of network traffic at a particular geographic location.

In some examples, the network measurement timer 204 includes means for determining when to collect network measurement data. For example, the means for determining when to collect network measurement data may be implemented by network measurement timer circuitry 204. In some examples, the network measurement timer circuitry 204 may be instantiated by processor circuitry such as the example processor circuitry 712 of FIG. 7. For instance, the network measurement timer circuitry 204 may be instantiated by the example general purpose processor circuitry 1000 of FIG. 10 executing machine executable instructions such as that implemented by at least block 402 of FIG. 4. In some examples, the network measurement timer circuitry 204 may be instantiated by hardware logic circuitry, which may be implemented by an ASIC or the FPGA circuitry 1100 of FIG. 11 structured to perform operations corresponding to the machine readable instructions. Additionally or alternatively, the network measurement timer circuitry 204 may be instantiated by any other combination of hardware, software, and/or firmware. For example, the network measurement timer circuitry 204 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the example of FIG. 2, the demographic controller 206 obtains demographic information from the respective device 104. In some examples, the demographic controller 206 requests demographic information at the time of registration. For example, the demographic controller 206 may generate a request for the device 104 to display during panelist registration, requesting age, gender, race, ethnicity, income level, home address, business address, marital status, etc. In some examples, the demographic controller 206 requests demographic information after registration, randomly or at the time of first network measurement data collection. In some examples, the demographic controller 206 may utilize panelist registration data to retrieve demographic information from the database proprietor 116. For example, the database proprietor 116 may include additional demographic information not captured during panelist registration. In such examples, the database proprietor 116 may supplement demographic information obtained during panelist registration.

In some examples, the demographic controller 206 includes means for obtaining demographic information. For example, the means for obtaining demographic information may be implemented by demographic controller circuitry 206. In some examples, the demographic controller circuitry 206 may be instantiated by processor circuitry such as the example processor circuitry 712 of FIG. 7. For instance, the demographic controller circuitry 206 may be instantiated by the example general purpose processor circuitry 1000 of FIG. 10 executing machine executable instructions such as that implemented by at least block 410 of FIG. 4. In some examples, the demographic controller circuitry 206 may be instantiated by hardware logic circuitry, which may be implemented by an ASIC or the FPGA circuitry 1100 of FIG. 11 structured to perform operations corresponding to the machine readable instructions. Additionally or alternatively, the demographic controller circuitry 206 may be instantiated by any other combination of hardware, software, and/or firmware. For example, the demographic controller circuitry 206 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In the example of FIG. 2, the meter datastore 208 stores and/or records data from the example modem 202 and the demographic controller 206. The example meter datastore 208 includes network measurement data 210 and demographic information 212. In this example, the network measurement data 210 is data obtained by the modem 202 and the demographic information 212 is data obtained by the demographic controller 206. The example meter datastore 208 may be implemented by a volatile memory (e.g., a Synchronous Dynamic Random Access Memory (SDRAM), Dynamic Random Access Memory (DRAM), RAMBUS Dynamic Random Access Memory (RDRAM), etc.) and/or a non-volatile memory (e.g., flash memory). The example meter datastore 208 may additionally or alternatively be implemented by one or more double data rate (DDR) memories, such as DDR, DDR2, DDR3, DDR4, mobile DDR (mDDR), etc. The example meter datastore 208 may additionally or alternatively be implemented by one or more mass storage devices such as hard disk drive(s), compact disk (CD) drive(s), digital versatile disk (DVD) drive(s), solid-state disk drive(s), etc. While in the illustrated example the meter datastore 208 is illustrated as a single datastore, the meter datastore 208 may be implemented by any number and/or type(s) of datastores. Furthermore, the data stored in the example meter datastore 208 may be in any data format such as, for example, binary data, comma delimited data, tab delimited data, structured query language (SQL) structures, etc.

While an example manner of implementing the meter 108 of FIG. 1 is illustrated in FIG. 2, one or more of the elements, processes and/or devices illustrated in FIG. 2 may be combined, divided, re-arranged, omitted, eliminated and/or implemented in any other way. Further, the example modem 202, the example network measurement timer 204, the example demographic controller 206, the example meter datastore 208, and/or, more generally, the example meter 108 of FIG. 2 may be implemented by hardware alone or by hardware in combination with software and/or firmware. Thus, for example, any of the example modem 202, the example network measurement timer 204, the example demographic controller 206, the example meter datastore 208 and/or, more generally, the example meter 108 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)) such as Field Programmable Gate Arrays (FPGAs). Further still, the example meter 108 of FIG. 1 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

A flowchart representative of example hardware logic, machine readable instructions, hardware implemented state machines, and/or any combination thereof for implementing the meter 108 of FIG. 2 is shown in FIG. 4 and described below.

FIG. 3 is a block diagram of the example central facility server 110 to generate reports of network provider performance. The example central facility server 110 of FIG. 3 may be instantiated (e.g., creating an instance of, bring into being for any length of time, materialize, implement, etc.) by processor circuitry such as a central processing unit executing instructions. Additionally or alternatively, the example central facility server 110 of FIG. 3 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 3 may be implemented by one or more virtual machines and/or containers executing on the microprocessor.

The example central facility server 110 includes an example central facility datastore 302, an example network performance analyzer 308, an example demographic collection controller 310, an example aggregating controller 312, and an example report generator 314.

In the example of FIG. 3, the central facility datastore 302 stores and/or records data from the example meters 108, the example demographic server 112, and/or the example collection server 114 of FIG. 1. The example central facility datastore 302 includes network measurement data 304, demographic information 306, and report(s) 316. The example central facility datastore 302 may be implemented by a volatile memory (e.g., an SDRAM, DRAM, RDRAM, etc.) and/or a non-volatile memory (e.g., flash memory). The example central facility datastore 302 may additionally or alternatively be implemented by one or more DDR memories, such as DDR, DDR2, DDR3, DDR4, mDDR, etc. The example central facility datastore 302 may additionally or alternatively be implemented by one or more mass storage devices such as hard disk drive(s), CD drive(s), DVD drive(s), solid-state disk drive(s), etc. While in the illustrated example the central facility datastore 302 is illustrated as a single datastore, the central facility datastore 302 may be implemented by any number and/or type(s) of datastores. Furthermore, the data stored in the central facility datastore 302 may be in any data format such as, for example, binary data, comma delimited data, tab delimited data, SQL structures, etc.

In FIG. 3, the example network performance analyzer 308 analyzes the network measurement data 304 to classify and/or identify the type of network performance of respective network providers 102. In some examples, the network performance analyzer 308 analyzes the network measurement data 304 in groups, where the groups may correspond to a location, a network provider, or a location and network provider. For example, the network performance analyzer 308 may select a network provider and a location to analyze, obtain the corresponding network measurement data 304, and then determine the network performance for that location and network provider. In some examples, the network performance analyzer 308 generates the groups of network measurement data corresponding to the location. In some examples, the network performance analyzer 308 provides the analyzed network measurement data 304 to the aggregating controller 312.

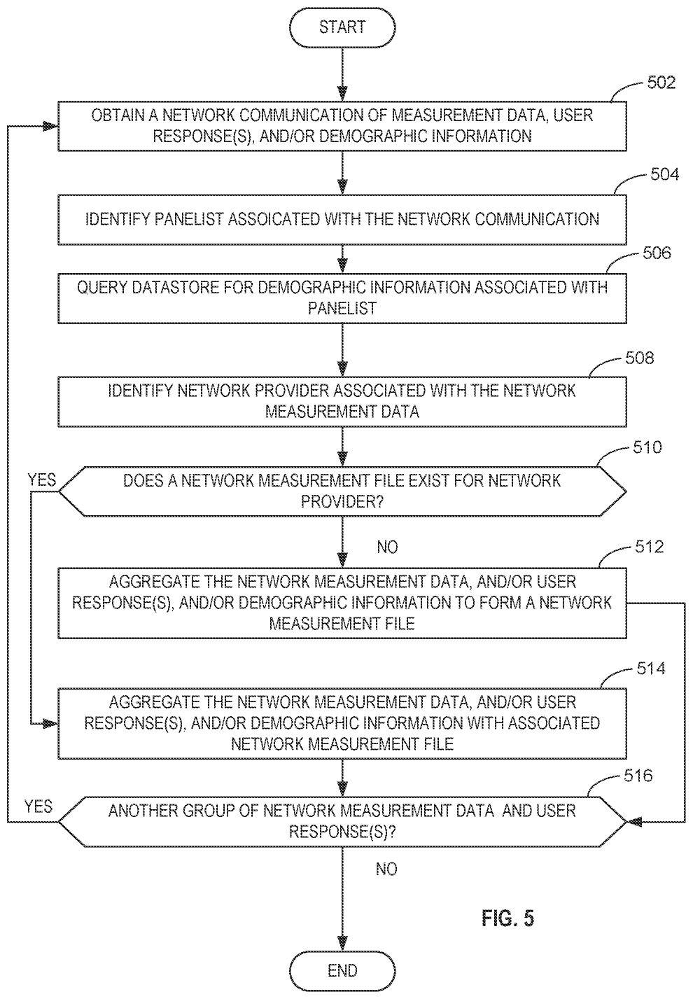

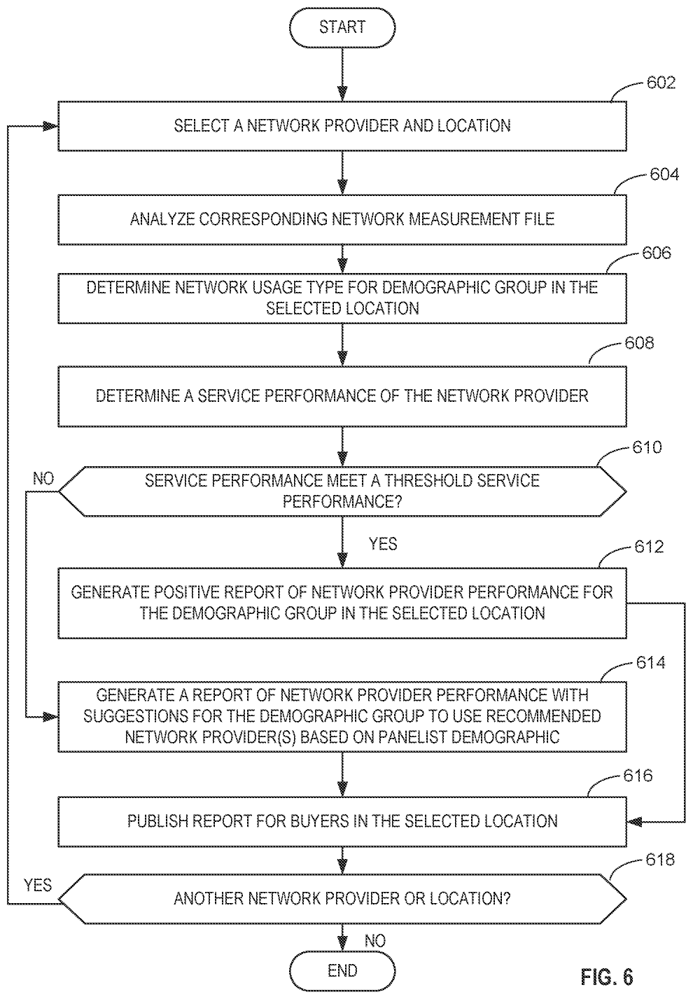

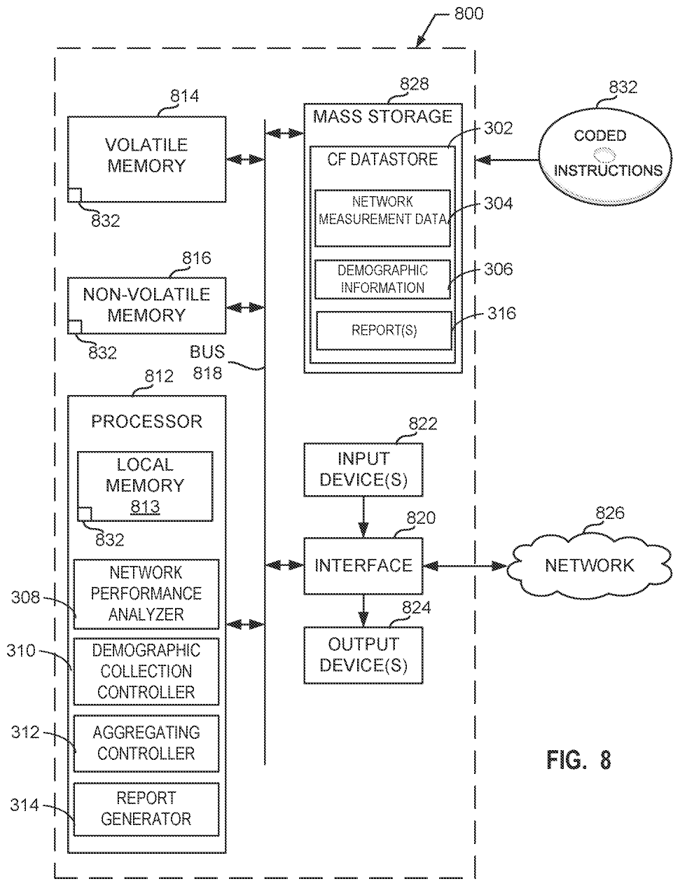

In some examples, the network performance analyzer 308 includes means for determining service performance of network providers. For example, the means for determining service performance of network providers may be implemented by network performance analyzer circuitry 308. In some examples, the network performance analyzer circuitry 308 may be instantiated by processor circuitry such as the example processor circuitry 812 of FIG. 8. For instance, the network performance analyzer circuitry 308 may be instantiated by the example general purpose processor circuitry 1000 of FIG. 10 executing machine executable instructions such as that implemented by at least blocks 502, 508, 510, 516, of FIG. 5 and/or at least blocks 602, 604, 606, 608, 610, 618 of FIG. 6. In some examples, the network performance analyzer circuitry 308 may be instantiated by hardware logic circuitry, which may be implemented by an ASIC or the FPGA circuitry 1100 of FIG. 11 structured to perform operations corresponding to the machine readable instructions. Additionally or alternatively, the network performance analyzer circuitry 308 may be instantiated by any other combination of hardware, software, and/or firmware. For example, the network performance analyzer circuitry 308 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for determining service performance of network providers includes means for obtaining survey responses, means for correlating demographic information with network measurement data, means for identifying files including one or more groups of network measurement data, and means for determining network usage types for a demographic group.

In FIG. 3, the example demographic collection controller 310 obtains the demographic information 306 that corresponds to the network measurement data 304 under inspection (e.g., being analyzed by the network performance analyzer 308). In some examples, the demographic collection controller 310 uses the panelist identifier mapped to the network measurement data 304 to obtain the corresponding demographic information 306. In some examples, the demographic collection controller 310 provides the demographic information 306 to the aggregating controller 312.

In some examples, the demographic collection controller 310 includes means for collecting and/or obtaining demographic information. For example, the means for collecting and/or obtaining demographic information may be implemented by demographic collection controller circuitry 310. In some examples, the demographic collection controller circuitry 310 may be instantiated by processor circuitry such as the example processor circuitry 812 of FIG. 8. For instance, the demographic collection controller circuitry 310 may be instantiated by the example general purpose processor circuitry 1000 of FIG. 10 executing machine executable instructions such as that implemented by at least blocks 504, 506 of FIG. 5. In some examples, the demographic collection controller circuitry 310 may be instantiated by hardware logic circuitry, which may be implemented by an ASIC or the FPGA circuitry 1100 of FIG. 11 structured to perform operations corresponding to the machine readable instructions. Additionally or alternatively, the demographic collection controller circuitry 310 may be instantiated by any other combination of hardware, software, and/or firmware. For example, the demographic collection controller circuitry 310 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the means for collecting and/or obtaining demographic information includes means for identifying panelists associated with demographic information and means for querying a datastore for demographic information associated with the panelist.

In FIG. 3, the example aggregating controller 312 aggregates the demographic information 306 and the analyzed network measurement data to form and/or generate a network measurement file. As used herein, a file is a computer-readable file that includes data and/or computer-executable instructions and is storable and accessible in computer memory. The network measurement file is a file of the demographic information, the network performance, the location, the network provider, and user experience with the network provider. In some examples, a single network measurement file is generated for a single network provider. For example, first network provider A 102a (FIG. 1) may have one file including network performance for all relevant locations. In some examples, multiple network measurement files may be generated for a single network provider. For example, second network provider B 102b (FIG. 1) may include a plurality of network measurement files corresponding to a plurality of locations.

For example, the aggregating controller 312 may aggregate first demographic information and first analyzed network measurement data to form a first network measurement file corresponding to the second network provider B 102b and location A, second demographic information and second analyzed network measurement data to form a second network measurement file corresponding to the second network provider B 102b and location B, third demographic information and third analyzed network measurement data to form a third network measurement file corresponding to the third network provider B 102b and location C, etc. In some examples, the first network measurement file may be indicative of a network performance that is different than a network performance of the second network measurement file (e.g., second network provider 102b provides worse network performance at location A than at location B). In some examples, the second network measurement file and the third network measurement file are indicative of an equal network performance, similar user experience, and a similar range of demographics (e.g., demographic age groups 16-18, 19-22, 22-35, 50+, etc.).

In some examples, the aggregating controller 312 includes means for aggregating network measurement data with user response information and/or with demographic information. For example, the means for aggregating network measurement data with user response information and/or demographic information may be implemented by aggregating controller circuitry 312. In some examples, the aggregating controller circuitry 312 may be instantiated by processor circuitry such as the example processor circuitry 812 of FIG. 8. For instance, the aggregating controller circuitry 312 may be instantiated by the example general purpose processor circuitry 1000 of FIG. 10 executing machine executable instructions such as that implemented by at least blocks 512, 514 of FIG. 5. In some examples, the aggregating controller circuitry 312 may be instantiated by hardware logic circuitry, which may be implemented by an ASIC or the FPGA circuitry 1100 of FIG. 11 structured to perform operations corresponding to the machine readable instructions. Additionally or alternatively, the aggregating controller circuitry 312 may be instantiated by any other combination of hardware, software, and/or firmware. For example, the aggregating controller circuitry 312 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate. In FIG. 3, the example report generator 314 obtains the network measurement files for the network providers 102 and generates a report 316 based on the information in the files. In some examples, the report is indicative of network provider performance with suggestions for the panelist(s) to use different network provider(s) based on panelist demographic(s). For example, the report may inform a buyer that is a male, 18 years old, and lives in a certain location, that network provider C 102c may be a better network provider than network providers 102a and 102b for the type of Internet service that 18 year old males typically use (e.g., gaming, video chatting, social media usage, etc.). In some examples, the report may inform a buyer that is female, 65 years old, and lives in a certain location, that network provider B 102b may be a better network provider than network providers 102a and 102c for the type of Internet usage that 65 year old females typically use (e.g., very little Internet usage relative to an 18 year old male).

In some examples, the report generator 314 includes means for generating a report. For example, the means for generating a report may be implemented by report generator circuitry 314. In some examples, the report generator circuitry 314 may be instantiated by processor circuitry such as the example processor circuitry 812 of FIG. 8. For instance, the report generator circuitry 314 may be instantiated by the example general purpose processor circuitry 1000 of FIG. 10 executing machine executable instructions such as that implemented by at least blocks 614, 616 of FIG. 6. In some examples, the report generator circuitry 314 may be instantiated by hardware logic circuitry, which may be implemented by an ASIC or the FPGA circuitry 1100 of FIG. 11 structured to perform operations corresponding to the machine readable instructions. Additionally or alternatively, the report generator circuitry 314 may be instantiated by any other combination of hardware, software, and/or firmware. For example, the report generator circuitry 314 may be implemented by at least one or more hardware circuits (e.g., processor circuitry, discrete and/or integrated analog and/or digital circuitry, an FPGA, an Application Specific Integrated Circuit (ASIC), a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the central facility server 110 of FIG. 1 is illustrated in FIG. 3, one or more of the elements, processes and/or devices illustrated in FIG. 3 may be combined, divided, re-arranged, omitted, eliminated and/or implemented in any other way. Further, the example central facility datastore 302, the example network performance analyzer 308, the example demographic collection controller 310, the example aggregating controller 312, the example report generator 314, and/or, more generally, the example central facility server 110 of FIG. 1 may be implemented by hardware alone or by hardware in combination with software and/or firmware. Thus, for example, any of the example central facility datastore 302, the example network performance analyzer 308, the example demographic collection controller 310, the example aggregating controller 312, the example report generator 314 and/or, more generally, the example central facility server 110 could be implemented by one or more analog or digital circuit(s), logic circuits, programmable processor(s), programmable controller(s), GPU(s), DSP(s), ASIC(s), PLD(s), and/or FPLD(s) such as FPGAs. Further still, the example central facility server 110 of FIG. 1 may include one or more elements, processes and/or devices in addition to, or instead of, those illustrated in FIG. 3, and/or may include more than one of any or all of the illustrated elements, processes and devices.

Flowcharts representative of example hardware logic, machine readable instructions, hardware implemented state machines, and/or any combination thereof for implementing the central facility server 110 of FIGS. 1 and 3 are shown in FIGS. 5-6.

The machine readable instructions of FIG. 4 may be one or more executable programs or portion(s) of an executable program for execution by a computer processor and/or processor circuitry, such as the processor 712 shown in the example processor platform 700 discussed below in connection with FIG. 7. The program(s) may be embodied in software stored on a non-transitory computer readable storage medium such as a CD-ROM, a floppy disk, a hard drive, a DVD, a Blu-ray disk, or a memory associated with the processor 712, but the entirety of the program(s) and/or parts thereof could alternatively be executed by a device other than the processor 712 and/or embodied in firmware or dedicated hardware. Further, although the example program(s) is/are described with reference to the flowchart illustrated in FIG. 4, many other methods of implementing the example meter 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions of FIGS. 5-6 may be one or more executable programs or portion(s) of an executable program for execution by a computer processor and/or processor circuitry, such as the processor 812 shown in the example processor platform 800 discussed below in connection with FIG. 8. The programs may be embodied in software stored on a non-transitory computer readable storage medium such as a CD-ROM, a floppy disk, a hard drive, a DVD, a Blu-ray disk, or a memory associated with the processor 812, but the entireties of the programs and/or parts thereof could alternatively be executed by a device other than the processor 812 and/or embodied in firmware or dedicated hardware. Further, although the example programs are described with reference to the flowcharts illustrated in FIGS. 5-6, many other methods of implementing the example central facility server 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more devices (e.g., a multi-core processor in a single machine, multiple processors distributed across a server rack, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement one or more functions that may together form a program such as that described herein.

In another example, the machine readable instructions may be stored in a state in which they may be read by processor circuitry, but require addition of a library (e.g., a dynamic link library (DLL)), an SDK, an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), SQL, Swift, etc.

As mentioned above, the example processes of FIGS. 4-6 may be implemented using executable instructions (e.g., computer and/or machine readable instructions) stored on a non-transitory computer and/or machine readable medium such as a hard disk drive, a flash memory, a read-only memory, a CD, a DVD, a cache, a random-access memory, and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a,” “an,” “first,” “second,” etc.) do not exclude a plurality. The term “a” or “an” entity, as used herein, refers to one or more of that entity. The terms “a” (or “an”), “one or more,” and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 4 is a flowchart representative of example machine readable instructions which may be executed and/or instantiated by processor circuitry to implement the meter 108 of FIGS. 1 and 2 to collect network measurement data 304 (FIG. 3) and demographic information 306 (FIG. 3). The program begins at block 402, where the example network measurement timer 204 (FIG. 2) waits for a first period of time for measuring network performance. For example, the network measurement timer 204 waits to notify the modem 202 (FIG. 2) to obtain the network measurement data 304. In some examples, the first period of time is a pre-determined value, determined based on times of a day corresponding to high network traffic patterns, determined based on a specific holiday and/or large Internet usage day (e.g., streaming sports or some live television show), and/or determined based on any type of factor relevant in identifying low performance networks and high performance networks in specific locations.

The example modem 202 obtains the network measurement data 304 (block 404). For example, the modem 202 is notified, by the network measurement timer 204, after the first period of time is expired to obtain the network measurement data 304.

The example modem 202 stores the network measurement data 304 with a time and location of collection (block 406). For example, the modem 202 stores the network measurement data 304 in the meter datastore 208 (FIG. 2) and may map the network measurement data 304 to a time and location of collection and/or may tag the network measurement data 304 with the time and location.

The example modem 202 determines if a second period of time for reporting service performance of the network provider 102 (FIG. 1) is expired (block 408). For example, the modem 202 is configured to send data from the meter datastore 208 to the central facility server 110 (FIG. 1) at intervals, such as once a week, once a month, a few times a year, etc. If the example modem 202 determines, at block 408, the second period of time is not expired, control returns to block 402.

If the example modem 202 determines, at block 408, the second period of time is expired, the demographic controller 206 (FIG. 2) requests user experience with the network (block 410). For example, the demographic controller 206 may generate a questionnaire or survey to request responses or feedback from the panelist regarding levels of satisfaction with speed, performance, latency, etc., of the Internet service(s). In some examples, the questionnaire or survey generated by the demographic controller 206 may request feedback from the panelist regarding perception of call quality, texting services, customer service, etc.

The example demographic controller 206 obtains user response(s) corresponding to a level of satisfaction of a subscriber to the network provider 102 (block 412). In the example of FIG. 4, the level of satisfaction pertaining to at least one of the services of the network provider 102. For example, the demographic controller 206 obtains a reply from the device (e.g., any of the devices 104 of FIG. 1) including information input by the panelist in response to the questionnaire or survey.

The example demographic controller 206 obtains demographic information (block 414). For example, the demographic controller 206 may include stored demographic information retrieved during panelist registration. In some examples, the demographic controller 206 queries the panelist for demographic information at a time after panelist registration. In some examples, the demographic controller 206 queries one or more database proprietors 116 for demographic information associated with the panelist.

The example modem 202 provides the network measurements, user response(s), and demographic information to the central facility server 110 (block 416). The example program of FIG. 4 ends. However, the example program may repeat after the modem 202 provides the information in the meter datastore 208 to the central facility server 110.

FIG. 5 is a flowchart representative of example machine readable instructions which may be executed and/or instantiated by processor circuitry to implement the central facility server 110 of FIGS. 1 and 3 to generate network measurement files for subsequent analysis. The example program of FIG. 5 begins at block 502 when the example network performance analyzer 308 (FIG. 3) obtains network communication (e.g., a network packet) of network measurement data, user response(s), and/or demographic information.

The example demographic collection controller 310 (FIG. 3) identifies the panelist associated with the network communication (block 504). For example, after the network performance analyzer 308 obtains the network communication, the network performance analyzer 308 may notify the demographic collection controller 310 to identify the corresponding panelist. In some examples, the network performance analyzer 308 identifies the panelist associated with the network communication.

The example demographic collection controller 310 queries the central facility datastore 302 (FIG. 3) for demographic information associated with the panelist (block 506). For example, the demographic collection controller 310 obtains the demographic information that corresponds to the network communication of network measurement data. In some examples, demographic information from the database proprietor 116 (FIG. 1) supplements the demographic information 212 (FIG. 2) from the modem 202 (FIG. 2) to generate the demographic information 306 (e.g., combined demographic information) stored in the central facility datastore 302. For example, the modem 202 of the meter 108 shown in FIG. 2 provides the demographic information 212, collected by the meter 108, to the central facility server 110. The central facility server 110 stores the demographic information 212 provided by the modem 202 and the demographic information provided by the database proprietor 116 (FIG. 1) in the central facility datastore 302. In such examples, the demographic information 212 provided by the modem 202 may be limited (e.g., only include age and gender) but the demographic information provided by the database proprietor 116 includes more types of information (e.g., race, ethnicity, income, marital status, job title, etc., in addition to age and gender and/or information missing from the demographic information 212). The demographic information 306 (e.g., combined demographic information) therefore includes more types of demographic information (e.g., a larger collection of demographic information per person, less-limited demographic information, etc.) in an example where the demographic information 212 provided by the modem 202 is limited.

The example network performance analyzer 308 identifies the network provider 102 (FIG. 1) associated with the network measurement data (block 508). For example, the network performance analyzer 308 may utilize information from and/or mapped to the panelist identifier to determine what subscription the panelist has for Internet service. In some examples, the network performance analyzer 308 may identify the network provider based on information from the device 104 hosting the meter 108, such as device configuration, etc.

The example network performance analyzer 308 determines if a file exists for the network provider 102 (block 510). For example, the network performance analyzer 308 may query the central facility datastore 302 to search for a corresponding file.

If, at block 510, the example network performance analyzer 308 does not find an existing file for the network provider 102, the example aggregating controller 312 aggregates the network measurement data, the user response(s), and/or the demographic information to form a network measurement file (block 512). For example, the network performance analyzer 308 provides the network measurement data and/or user responses to the aggregating controller 312 (FIG. 3), and/or the demographic collection controller 310 provides the demographic information to the aggregating controller 312.

If, at block 510, the example network performance analyzer 308 does find an existing file for the network provider 102, the aggregating controller 312 aggregates the network measurement data, user response(s), and/or demographic information with the associated network measurement file (block 514). For example, the network performance analyzer 308 notifies the aggregating controller 312 of the existing file and provides the network measurement data, and/or user response(s), and/or the demographic collection controller 310 provides the demographic information to the aggregating controller 312 to use for generating the network measurement file.

The example network performance analyzer 308 determines if there is another group of network measurement data and/or user response(s) (block 516). If the example network performance analyzer 308 determines there is another group, control returns to block 502. If the example network performance analyzer 308 determines, at block 516, that there is not another group, the program of FIG. 5 ends. The example program of FIG. 5 ends. However, the program may be repeated when new packets of network measurement data are received.

FIG. 6 is a flowchart representative of machine readable instructions which may be executed and/or instantiated by processor circuitry to implement the central facility server 110 of FIGS. 1 and 3 to generate report(s) of network performance. The example program of FIG. 6 begins at block 602 when the example network performance analyzer 308 (FIG. 3) selects a network provider 102 (FIG. 1) and a location. For example, the network performance analyzer 308 selects from a list of network providers and corresponding locations to analyze.

The example network performance analyzer 308 analyzes the corresponding network measurement file (block 604). For example, the network performance analyzer 308 may compare the data in the file to threshold data indicative of different performance levels. For example, first threshold data may be indicative of low quality network performance, second threshold data may be indicative of medium quality network performance, and a third threshold data may be indicative of high quality network performance. Other methods for analyzing the files may be used.

The example network performance analyzer 308 determines the network usage type for the demographic group in the selected location (block 606). For example, the network performance analyzer 308 determines the types of device usages such as streaming services, gaming apps, voice calls, video calls, text messages, emails, web browsing, etc. In some examples, the network performance analyzer 308 can identify such network usage type based on the network measurement data 210, 304 (FIGS. 2 and 3) (e.g., based on the type of metrics in the network measurement data). For example, if the network measurement data 210, 304 includes metrics associated with traceroute commands, the network performance analyzer 308 can determine that a user may have frequently browsed the Internet.

The example network performance analyzer 308 determines a service performance of the network provider 102 (block 608). In the example of FIG. 6, the network performance analyzer 308 determines the service performance of the network provider 102 for the network usage type in the selected location based on demographic information and network measurement data. For example, the network performance analyzer 308 determines, based on the analysis of the network measurement file, whether the network performance was of high quality for the type of network usage in the area which the device 104 and/or meter 108 were/are registered, was of low quality, and/or was of medium quality.

The example network performance analyzer 308 determines whether the service performance meets a threshold service performance (block 610). For example, the network performance analyzer 308 determines whether the comparisons of the network measurement data 210, 304 in the network measurement files to the threshold network measurement data are indicative of a high quality service performance of the network provider 102.

If the example network performance analyzer 308 determines, at block 610, that the service performance does meet the service performance threshold, the example report generator 314 (FIG. 3) generates a positive report of the service performance of the network provider for the demographic group in the selected location (block 612). In some examples, a positive report may indicate that the network provider 102 is optimal or relatively better than other network providers 102 for providing a type of service for a particular network usage type.

If the example network performance analyzer 308 determines, at block 610, that the service performance does not meet the service performance threshold, the report generator 314 generates a report of the service performance with suggestions for the demographic group to use recommended network provider(s) 102 based on the panelist demographic (block 614). For example, if the service performance was of low quality for an 18-year old male using video calling and gaming services on a weekly basis, the report generator 314 generates a report that includes recommendations to use network providers 102 that provide better and/or higher quality service performance for that particular network usage type.

The example report generator 314 publishes the report for buyers in the selected location (block 616). For example, the report generator 314 uploads, posts, prints, etc., the report for access by people who pay to view the report.

The example network performance analyzer 308 determines whether there is another network provider or location to analyze (block 618). If the example network performance analyzer 308 determines, at block 618, that there is not another network provider or location, the program of FIG. 6 ends. If the example network performance analyzer 308 determines, at block 618, that there is another network provider or location to analyze, control returns to block 602.

FIG. 7 is a block diagram of an example processor platform 700 structured to execute the instructions of FIG. 4 to implement the meter 108 of FIGS. 1 and 2. The processor platform 700 can be, for example, a server, a personal computer, a workstation, a self-learning machine (e.g., a neural network), a mobile device (e.g., a cell phone, a smart phone, a tablet such as an iPad® tablet), a personal digital assistant (PDA), an Internet appliance, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 712 implements the example network measurement timer 204 and the example demographic controller 206.

The processor 712 of the illustrated example includes a local memory 713 (e.g., a cache). The processor 712 of the illustrated example is in communication with a main memory including a volatile memory 714 and a non-volatile memory 716 via a bus 718. The volatile memory 714 may be implemented by SDRAM, DRAM, RDRAM®, and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB) interface, a Bluetooth® interface, a near field communication (NFC) interface, and/or a Peripheral Component Interface (PCI) express interface. In this example, the interface circuit 720 implements the example modem 202 of FIG. 2.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives. In this example, the mass storage devices 728 implement the example meter datastore 208, which includes the example network measurement data 210 and the example demographic information 212 of FIG. 2.

Example machine executable instructions 732 represented in FIG. 4 may be stored in the mass storage device 728, in the volatile memory 714, in the non-volatile memory 716, and/or on a removable non-transitory computer readable storage medium such as a CD or DVD.

FIG. 8 is a block diagram of an example processor platform 800 structured to execute the instructions of FIGS. 5-6 to implement the central facility server 110 of FIGS. 1 and 3. The processor platform 800 can be, for example, a server, a personal computer, a workstation, a self-learning machine (e.g., a neural network), a mobile device (e.g., a cell phone, a smart phone, a tablet such as an iPad® tablet), a personal digital assistant (PDA), an Internet appliance, or any other type of computing device.

The processor platform 800 of the illustrated example includes a processor 812. The processor 812 of the illustrated example is hardware. For example, the processor 812 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 812 implements the example network performance analyzer 308, the example demographic collection controller 310, the example aggregating controller 312, and the example report generator 314.

The processor 812 of the illustrated example includes a local memory 813 (e.g., a cache). The processor 812 of the illustrated example is in communication with a main memory including a volatile memory 814 and a non-volatile memory 816 via a bus 818. The volatile memory 814 may be implemented by SDRAM, DRAM, RDRAM®, and/or any other type of random access memory device. The non-volatile memory 816 may be implemented by flash memory and/or any other desired type of memory device. Access to the main memory 814, 816 is controlled by a memory controller.

The processor platform 800 of the illustrated example also includes an interface circuit 820. The interface circuit 820 may be implemented by any type of interface standard, such as an Ethernet interface, a USB interface, a Bluetooth® interface, an NFC interface, and/or a PCI express interface.

In the illustrated example, one or more input devices 822 are connected to the interface circuit 820. The input device(s) 822 permit(s) a user to enter data and/or commands into the processor 812. The input device(s) can be implemented by, for example, an audio sensor, a microphone, a camera (still or video), a keyboard, a button, a mouse, a touchscreen, a track-pad, a trackball, an isopoint device, and/or a voice recognition system.

One or more output devices 824 are also connected to the interface circuit 820 of the illustrated example. The output devices 824 can be implemented, for example, by display devices (e.g., an LED, an OLED, an LCD, a CRT display, an IPS display, a touchscreen, etc.), a tactile output device, a printer, and/or speaker. The interface circuit 820 of the illustrated example, thus, typically includes a graphics driver card, a graphics driver chip and/or a graphics driver processor.

The interface circuit 820 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 826. The communication can be via, for example, an Ethernet connection, a digital subscriber line (DSL) connection, a telephone line connection, a coaxial cable system, a satellite system, a line-of-site wireless system, a cellular telephone system, etc.

The processor platform 800 of the illustrated example also includes one or more mass storage devices 828 for storing software and/or data. Examples of such mass storage devices 828 include floppy disk drives, hard drive disks, compact disk drives, Blu-ray disk drives, redundant array of independent disks (RAID) systems, and digital versatile disk (DVD) drives. In this example, the mass storage devices 828 implement the example central facility datastore 302, which includes the network measurement data 304, the demographic information 306, and the report(s) 316 of FIG. 3.

Example machine executable instructions 832 represented in FIGS. 5-6 may be stored in the mass storage device 828, in the volatile memory 814, in the non-volatile memory 816, and/or on a removable non-transitory computer readable storage medium such as a CD or DVD.

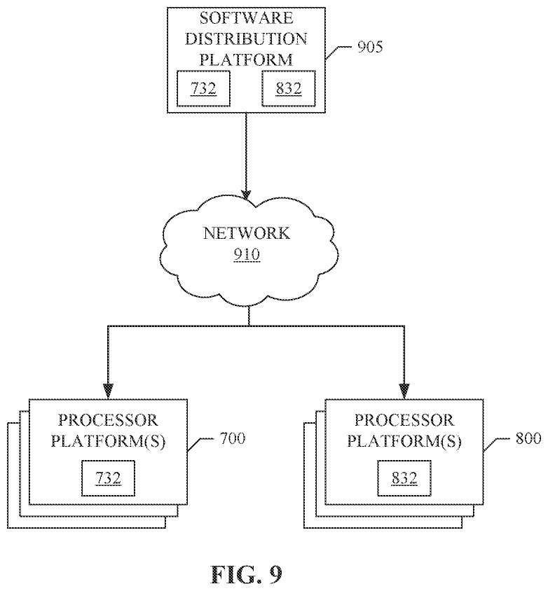

A block diagram illustrating an example software distribution platform 905 to distribute software such as the example computer readable instructions 732 of FIG. 7 and/or the example computer readable instructions 832 of FIG. 8 to third parties is illustrated in FIG. 9. The example software distribution platform 905 may be implemented by any computer server, data facility, cloud service, etc., capable of storing and transmitting software to other computing devices. The third parties may be customers of the entity owning and/or operating the software distribution platform. For example, the entity that owns and/or operates the software distribution platform may be a developer, a seller, and/or a licensor of software such as the example computer readable instructions 732 of FIG. 7 and/or the example computer readable instructions 832 of FIG. 8. The third parties may be consumers, users, retailers, OEMs, etc., who purchase and/or license the software for use and/or re-sale and/or sub-licensing. In the illustrated example, the software distribution platform 905 includes one or more servers and one or more storage devices. The storage devices store the computer readable instructions 732, 832, which may correspond to the example computer readable instructions of FIGS. 4, 5, and/or 6, as described above. The one or more servers of the example software distribution platform 905 are in communication with a network 910, which may correspond to any one or more of the Internet and/or any of the example networks 106, 726, 826 described above. In some examples, the one or more servers are responsive to requests to transmit the software to a requesting party as part of a commercial transaction. Payment for the delivery, sale and/or license of the software may be handled by the one or more servers of the software distribution platform and/or via a third party payment entity. The servers enable purchasers and/or licensors to download the computer readable instructions 732, 832 from the software distribution platform 905. For example, the software, which may correspond to the example computer readable instructions of FIG. 4, may be downloaded to one(s) of the example processor platform 700 of FIG. 7, which is/are to execute the computer readable instructions 732 to implement the meter 108 of FIGS. 1 and/or 2. In some examples, the software, which may correspond to the example computer readable instructions of FIGS. 5-6, may be downloaded to one(s) of the example processor platform 800 of FIG. 8, which is/are to execute the computer readable instructions 832 to implement the central facility server 110 of FIGS. 1 and/or 3. In some example, one or more servers of the software distribution platform 905 periodically offer, transmit, and/or force updates to the software (e.g., the example computer readable instructions 732 of FIG. 7 and/or the example computer readable instructions 832 of FIG. 8) to ensure improvements, patches, updates, etc., are distributed and applied to the software at the end user devices.

FIG. 10 is a block diagram of an example implementation of the processor circuitry 712 of FIG. 7 and/or the processor circuitry 812 of FIG. 8. In this example, the processor circuitry 712 of FIG. 7 and/or the processor circuitry 812 of FIG. 8 is implemented by a general purpose microprocessor 1000. The general purpose microprocessor circuitry 1000 executes some or all of the machine readable instructions of the flowchart of FIGS. 4-6 to effectively instantiate the circuitry of FIGS. 1-3 as logic circuits to perform the operations corresponding to those machine readable instructions. In some such examples, the circuitry of FIGS. is instantiated by the hardware circuits of the microprocessor 1000 in combination with the instructions. For example, the microprocessor 1000 may implement multi-core hardware circuitry such as a CPU, a DSP, a GPU, an XPU, etc. Although it may include any number of example cores 1002 (e.g., 1 core), the microprocessor 1000 of this example is a multi-core semiconductor device including N cores. The cores 1002 of the microprocessor 1000 may operate independently or may cooperate to execute machine readable instructions. For example, machine code corresponding to a firmware program, an embedded software program, or a software program may be executed by one of the cores 1002 or may be executed by multiple ones of the cores 1002 at the same or different times. In some examples, the machine code corresponding to the firmware program, the embedded software program, or the software program is split into threads and executed in parallel by two or more of the cores 1002. The software program may correspond to a portion or all of the machine readable instructions and/or operations represented by the flowchart of FIGS. 4-6.

The cores 1002 may communicate by a first example bus 1004. In some examples, the first bus 1004 may implement a communication bus to effectuate communication associated with one(s) of the cores 1002. For example, the first bus 1004 may implement at least one of an Inter-Integrated Circuit (I2C) bus, a Serial Peripheral Interface (SPI) bus, a PCI bus, or a PCIe bus. Additionally or alternatively, the first bus 1004 may implement any other type of computing or electrical bus. The cores 1002 may obtain data, instructions, and/or signals from one or more external devices by example interface circuitry 1006. The cores 1002 may output data, instructions, and/or signals to the one or more external devices by the interface circuitry 1006. Although the cores 1002 of this example include example local memory 1020 (e.g., Level 1 (L1) cache that may be split into an L1 data cache and an L1 instruction cache), the microprocessor 1000 also includes example shared memory 1010 that may be shared by the cores (e.g., Level 2 (L2_cache)) for high-speed access to data and/or instructions. Data and/or instructions may be transferred (e.g., shared) by writing to and/or reading from the shared memory 1010. The local memory 1020 of each of the cores 1002 and the shared memory 1010 may be part of a hierarchy of storage devices including multiple levels of cache memory and the main memory (e.g., the main memory 714, 716 of FIG. 7 and/or main memory 814, 816 of FIG. 8). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1002 may be referred to as a CPU, DSP, GPU, etc., or any other type of hardware circuitry. Each core 1002 includes control unit circuitry 1014, arithmetic and logic (AL) circuitry (sometimes referred to as an ALU) 1016, a plurality of registers 1018, the L1 cache 1020, and a second example bus 1022. Other structures may be present. For example, each core 1002 may include vector unit circuitry, single instruction multiple data (SIMD) unit circuitry, load/store unit (LSU) circuitry, branch/jump unit circuitry, floating-point unit (FPU) circuitry, etc. The control unit circuitry 1014 includes semiconductor-based circuits structured to control (e.g., coordinate) data movement within the corresponding core 1002. The AL circuitry 1016 includes semiconductor-based circuits structured to perform one or more mathematic and/or logic operations on the data within the corresponding core 1002. The AL circuitry 1016 of some examples performs integer based operations. In other examples, the AL circuitry 1016 also performs floating point operations. In yet other examples, the AL circuitry 1016 may include first AL circuitry that performs integer based operations and second AL circuitry that performs floating point operations. In some examples, the AL circuitry 1016 may be referred to as an Arithmetic Logic Unit (ALU). The registers 1018 are semiconductor-based structures to store data and/or instructions such as results of one or more of the operations performed by the AL circuitry 1016 of the corresponding core 1002. For example, the registers 1018 may include vector register(s), SIMD register(s), general purpose register(s), flag register(s), segment register(s), machine specific register(s), instruction pointer register(s), control register(s), debug register(s), memory management register(s), machine check register(s), etc. The registers 1018 may be arranged in a bank as shown in FIG. 10. Alternatively, the registers 1018 may be organized in any other arrangement, format, or structure including distributed throughout the core 1002 to shorten access time. The second bus 1022 may implement at least one of an I2C bus, a SPI bus, a PCI bus, or a PCIe bus

Each core 1002 and/or, more generally, the microprocessor 1000 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1000 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 11 is a block diagram of another example implementation of the processor circuitry 712 of FIG. 7 and/or the processor circuitry 812 of FIG. 8. In this example, the processor circuitry 712 of FIG. 7 and/or the processor circuitry 812 is implemented by FPGA circuitry 1100. The FPGA circuitry 1100 can be used, for example, to perform operations that could otherwise be performed by the example microprocessor 1000 of FIG. 10 executing corresponding machine readable instructions. However, once configured, the FPGA circuitry 1100 instantiates the machine readable instructions in hardware and, thus, can often execute the operations faster than they could be performed by a general purpose microprocessor executing the corresponding software.

More specifically, in contrast to the microprocessor 1000 of FIG. 10 described above (which is a general purpose device that may be programmed to execute some or all of the machine readable instructions represented by the flowcharts of FIGS. 4-6 but whose interconnections and logic circuitry are fixed once fabricated), the FPGA circuitry 1100 of the example of FIG. 11 includes interconnections and logic circuitry that may be configured and/or interconnected in different ways after fabrication to instantiate, for example, some or all of the machine readable instructions represented by the flowcharts of FIGS. 4-6. In particular, the FPGA 1100 may be thought of as an array of logic gates, interconnections, and switches. The switches can be programmed to change how the logic gates are interconnected by the interconnections, effectively forming one or more dedicated logic circuits (unless and until the FPGA circuitry 1100 is reprogrammed). The configured logic circuits enable the logic gates to cooperate in different ways to perform different operations on data received by input circuitry. Those operations may correspond to some or all of the software represented by the flowcharts of FIGS. 4-6. As such, the FPGA circuitry 1100 may be structured to effectively instantiate some or all of the machine readable instructions of the flowcharts of FIG. 4-6 as dedicated logic circuits to perform the operations corresponding to those software instructions in a dedicated manner analogous to an ASIC. Therefore, the FPGA circuitry 1100 may perform the operations corresponding to the some or all of the machine readable instructions of FIGS. 4-6 faster than the general purpose microprocessor can execute the same.

In the example of FIG. 11, the FPGA circuitry 1100 is structured to be programmed (and/or reprogrammed one or more times) by an end user by a hardware description language (HDL) such as Verilog. The FPGA circuitry 1100 of FIG. 11, includes example input/output (I/O) circuitry 1102 to obtain and/or output data to/from example configuration circuitry 1104 and/or external hardware (e.g., external hardware circuitry) 1106. For example, the configuration circuitry 1104 may implement interface circuitry that may obtain machine readable instructions to configure the FPGA circuitry 1100, or portion(s) thereof. In some such examples, the configuration circuitry 1104 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1106 may implement the microprocessor 1000 of FIG. 10. The FPGA circuitry 1100 also includes an array of example logic gate circuitry 1108, a plurality of example configurable interconnections 1110, and example storage circuitry 1112. The logic gate circuitry 1108 and interconnections 1110 are configurable to instantiate one or more operations that may correspond to at least some of the machine readable instructions of FIGS. 4-6 and/or other desired operations. The logic gate circuitry 1108 shown in FIG. 11 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1108 to enable configuration of the electrical structures and/or the logic gates to form circuits to perform desired operations. The logic gate circuitry 1108 may include other electrical structures such as look-up tables (LUTs), registers (e.g., flip-flops or latches), multiplexers, etc.

The interconnections 1110 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1108 to program desired logic circuits.

The storage circuitry 1112 of the illustrated example is structured to store result(s) of the one or more of the operations performed by corresponding logic gates. The storage circuitry 1112 may be implemented by registers or the like. In the illustrated example, the storage circuitry 1112 is distributed amongst the logic gate circuitry 1108 to facilitate access and increase execution speed.

The example FPGA circuitry 1100 of FIG. 11 also includes example Dedicated Operations Circuitry 1114. In this example, the Dedicated Operations Circuitry 1114 includes special purpose circuitry 1116 that may be invoked to implement commonly used functions to avoid the need to program those functions in the field. Examples of such special purpose circuitry 1116 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1100 may also include example general purpose programmable circuitry 1118 such as an example CPU 1120 and/or an example DSP 1122. Other general purpose programmable circuitry 1118 may additionally or alternatively be present such as a GPU, an XPU, etc., that can be programmed to perform other operations.

Although FIGS. 10 and 11 illustrate two example implementations of the processor circuitry 712 of FIG. 7 and/or the processor circuitry 812 of FIG. 8, many other approaches are contemplated. For example, as mentioned above, modern FPGA circuitry may include an on-board CPU, such as one or more of the example CPU 1120 of FIG. 11. Therefore, the processor circuitry 712 of FIG. 7 and/or the processor circuitry 812 of FIG. 8 may additionally be implemented by combining the example microprocessor 1000 of FIG. 10 and the example FPGA circuitry 1100 of FIG. 11. In some such hybrid examples, a first portion of the machine readable instructions represented by the flowcharts of FIGS. 4-6 may be executed by one or more of the cores 1002 of FIG. 10, a second portion of the machine readable instructions represented by the flowcharts of FIGS. 4-6 may be executed by the FPGA circuitry 1100 of FIG. 11, and/or a third portion of the machine readable instructions represented by the flowcharts of FIGS. 4-6 may be executed by an ASIC. It should be understood that some or all of the circuitry of FIGS. 1-4 may, thus, be instantiated at the same or different times. Some or all of the circuitry may be instantiated, for example, in one or more threads executing concurrently and/or in series. Moreover, in some examples, some or all of the circuitry of FIGS. 1-4 may be implemented within one or more virtual machines and/or containers executing on the microprocessor.

In some examples, the processor circuitry 712 of FIG. 7 and/or the processor circuitry 812 of FIG. 8 may be in one or more packages. For example, the processor circuitry 1000 of FIG. 10 and/or the FPGA circuitry 1100 of FIG. 11 may be in one or more packages. In some examples, an XPU may be implemented by the processor circuitry 712 of FIG. 7 and/or the processor circuitry 812 of FIG. 8, which may be in one or more packages. For example, the XPU may include a CPU in one package, a DSP in another package, a GPU in yet another package, and an FPGA in still yet another package.

From the foregoing, it will be appreciated that example systems, methods, apparatus, and articles of manufacture have been disclosed that generate reports indicative of recommendations of network providers to use and/or subscribe to in particular locations, for different network usage types, and/or for different demographic. Examples disclosed herein monitor network performance via a plurality of meters installed and/or executed by user devices that are registered and/or owned by panelists. Advantageously, examples disclosed herein correlate demographic information of the panelists with the network performance to create computer-generated recommendations of network providers per demographic type.

Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

The following claims are hereby incorporated into this Detailed Description by this reference, with each claim standing on its own as a separate embodiment of the present disclosure.

What is claimed is:

1. An apparatus comprising:
a network performance analyzer to determine a service performance of a first network provider based on demographic information and network measurement data, the demographic information corresponding to subscribers of the first network provider, the network measurement data corresponding to services of the first network provider; and
a report generator to generate a report of the service performance of the first network provider, the report including a recommendation for a demographic group to use a second network provider based on the service performance not satisfying a threshold, the second network provider different from the first network provider.

2. The apparatus of claim 1, wherein the network performance analyzer is to obtain a survey response corresponding to a level of satisfaction of a subscriber to the first network provider, the level of satisfaction pertaining to at least one of the services of the first network provider.

3. The apparatus of claim 2, wherein the network performance analyzer is to determine the service performance of the first network provider based on the survey response.

4. The apparatus of claim 1, further including an aggregating controller to:
obtain a first network communication including second network measurement data and second demographic information;
aggregate the second network measurement data and the second demographic information with third network measurement data and third demographic information from a second network communication, the first and second network communications corresponding to a same location and to the first network provider; and
store the aggregated second network measurement data, the second demographic information, the third network measurement data, and the third demographic information in memory to update the report of the service performance of the first network provider.

5. The apparatus of claim 1, further including an aggregating controller,
the network performance analyzer to:
correlate the demographic information with the network measurement data corresponding to the first network provider;
identify if a file exists for the first network provider at a first location, the file to include one or more groups of network measurement data corresponding to the first network provider and to the first location; and
the aggregating controller to, in response to not identifying the file for the first network provider at the first location, aggregate the network measurement data and the demographic information to store an aggregation of the network measurement data and the demographic information in a network measurement file.

6. The apparatus of claim 1, wherein:
the network performance analyzer is to determine a network usage type in a location for the demographic group; and
the report generator is to generate the recommendation based on the demographic group and the corresponding network usage type for that demographic group.

7. The apparatus of claim 1, further including a report generator to publish the report.

8. A non-transitory computer readable storage medium comprising instructions that, when executed, cause at least one processor to at least:
determine a service performance of a first network provider based on demographic information and network measurement data, the demographic information corresponding to subscribers of the first network provider, the network measurement data corresponding to services of the first network provider; and
generate a report of the service performance of the first network provider, the report including a recommendation for a demographic group to use a second network provider based on the service performance not satisfying a threshold, the second network provider different from the first network provider.

9. The non-transitory computer readable storage medium of claim 8, wherein the instructions are further to cause the at least one processor to obtain a survey response corresponding to a level of satisfaction of a subscriber to the first network provider, the level of satisfaction pertaining to at least one of the services of the first network provider.

10. The non-transitory computer readable storage medium of claim 9, wherein the instructions are further to cause the at least one processor to determine the service performance of the first network provider based on the survey response.

11. The non-transitory computer readable storage medium of claim 8, wherein the instructions are further to cause the at least one processor to:
obtain a first network communication including second network measurement data and second demographic information;
aggregate the second network measurement data and the second demographic information with third network measurement data and third demographic information from a second network communication, the first and second network communications corresponding to a same location and to the first network provider; and
store the aggregated second network measurement data, the second demographic information, the third network measurement data, and the third demographic information in memory to update the report of the service performance of the first network provider.

12. The non-transitory computer readable storage medium of claim 8, wherein the instructions are further to cause the at least one processor to:
correlate the demographic information with the network measurement data corresponding to the first network provider;
identify if a file exists for the first network provider at a first location, the file to include one or more groups of network measurement data corresponding to the first network provider and to the first location; and
in response to not identifying the file for the first network provider at the first location, aggregate the network measurement data and the demographic information to form a network measurement file.

13. The non-transitory computer readable storage medium of claim 8, wherein the instructions are further to cause the at least one processor to:
determine a network usage type in a location for the demographic group; and
generate the recommendation based on the demographic group and the corresponding network usage type for that demographic group.

14. The non-transitory computer readable storage medium of claim 8, wherein the instructions are further to cause the at least one processor to publish the report.

15. A method comprising:
determining a service performance of a first network provider based on demographic information and network measurement data, the demographic information corresponding to subscribers of the first network provider, the network measurement data corresponding to services of the first network provider; and
generating a report of the service performance of the first network provider, the report including a recommendation for a demographic group to use a second network provider based on the service performance not satisfying a threshold, the second network provider different from the first network provider.

16. The method of claim 15, further including obtaining a survey response corresponding to a level of satisfaction of a subscriber to the first network provider, the level of satisfaction pertaining to at least one of the services of the first network provider.

17. The method of claim 16, further including determining the service performance of the first network provider based on the survey response.

18. The method of claim 15, further including:
obtaining a first network communication including second network measurement data and second demographic information;
aggregating the second network measurement data and the second demographic information with third network measurement data and third demographic information from a second network communication, the first and second network communications corresponding to a same location and to the first network provider; and
storing the aggregated second network measurement data, the second demographic information, the third network measurement data, and the third demographic information in memory to update the report of the service performance of the first network provider.

19. The method of claim 15, further including:
associating the demographic information with the network measurement data corresponding to the first network provider;
identifying if a file exists for the first network provider at a first location, the file to include one or more groups of network measurement data corresponding to the first network provider and to the first location; and
in response to not identifying the file for the first network provider at the first location, create a network measurement file to store an aggregation of the network measurement data and the demographic information.

20. The method of claim 15, further including:
determining a network usage type in a location for the demographic group; and
generating the recommendation based on the demographic group and the corresponding network usage type for that demographic group.
